(19) United States
(12) Patent Application Publication
(10) Pub. No.: US 2001/0006380 A1
(43) Pub. Date: Jul. 5, 2001

(54) Colored back light device in liquid crystal display module

(75) Inventor: Byeong-Ro Jeong, Seoul (KR)

Correspondence Address: Paul J. Farrell, Esq., DILWORTH & BARRESE, 333 Earle Ovington Boulevard, Uniondale, NY, 11553, US

(73) Assignee: Samsung Electronics Co.

(21) Appl. No.: 09/753,116

(22) Filed: Jan. 2, 2001

(30) Foreign Application Priority Data
Dec. 31, 1999 (KR) 1999-68266

(51) Int. Cl. G09G 3/36

(52) U.S. Cl. 345/102

(57) ABSTRACT

Disclosed is a back light in a liquid crystal display (LCD) module, in particular, a back light device in a LCD module for irradiating light in a variety of colors according to a user's demand. The back light device in the liquid crystal display module includes a liquid crystal display, a reflecting plate laminated sheet by sheet on a bottom of the liquid crystal display, one or more lamps installed on one end of the reflecting plate, and a controller for controlling light emission of the installed lamps. The lamps are installed on both ends of the reflecting plate to combine colors. The light emitted by the lamps is diffused through the reflecting plate. The diffused light is irradiated according to an illumination control signal applied by the controller. The illumination control signal causes the irradiated light to have a pertinent color according to the user's demand.

### BACKGROUND OF THE INVENTION

1. Field of the Invention

The present invention generally relates to a back light device in a liquid crystal display (LCD) module, and in particular, to a back light device in a liquid crystal display module for irradiating light in various colors according to a demand by a user.

2. Description of the Related Art

In general, a liquid crystal display module refers a device used in a small-sized information equipment to display information. The typical liquid crystal display module as currently produced may be used as a display monitor for a small television set, a mobile telecommunication set, or the like.

A problem, however, encountered in the liquid crystal display module of the prior art is that a user can not see the displayed information in a dark place due to its original characteristics. Thus, an additional illuminating device referred to as a back light device is housed in the liquid crystal display module, so that a user can see the displayed information even in the dark place due to the operation of the housed illuminating device.

FIG. 1 is a schematic view illustrating an inside structure of the liquid crystal display module in the prior art. FIG. 1a represents a case where a back light device is realized as a lamp element of light emitting diode (LED) or the like, while FIG. 1b represents a case where a back light device is realized as an E.L. (electro-luminescent) sheet currently developed. Most presently used liquid crystal display modules have a structure as shown in FIG. 1, respectively. In particular, the structure of the liquid crystal display module in FIG. 1 is a representative illustration applied as a display monitor for a mobile telecommunication set widely used at the present time.

In the meantime, it is found the back light device in the liquid crystal display module as shown in FIG. 1 is designed to emit unicolored light. In other words, the back light device in the liquid crystal display module of the prior art is fabricated to emit light in a predetermined color irrespective of various tastes or requests by users.

With various tastes or requests by users, there is a need to produce the liquid crystal display module capable of emitting light in a variety of colors. There are some liquid crystal display modules designed to emit light with at least one color. Those liquid crystal display modules, in practice, can only select a few among several predetermined several colors, and the problem of illumination in an unicolored state still remains.

### SUMMARY OF THE INVENTION

It is, therefore, an object of the present invention to provide a liquid crystal display (LCD) module, which can combine and emit light having a variety of colors according to a user's request, thereby obviating a limitation of the prior art in the inability to emit light of various colors.

To achieve the above object, there is provided a back light device in a liquid crystal display module, the device comprising a liquid crystal display, a reflecting plate laminated sheet by sheet on a bottom of the liquid crystal display, one or more lamps installed on one end of the reflecting plate, and a controller for controlling light emission of the lamps. The lamps are installed on both ends of a bottom of the reflecting plate to combine colors. The light emitted by the lamps is diffused through the reflecting plate. The diffused light is irradiated according to an illumination control signal applied by the controller. The illumination control signal is a signal for controlling emission of the light in a particular color requested by a user.

### BRIEF DESCRIPTION OF THE DRAWINGS

The above and other objects, features and advantages of the present invention will become more apparent from the following detailed description when taken in conjunction with the accompanying drawings, in which:

FIG. 1 is a diagram illustrating a back light device in a prior art liquid crystal display module; and

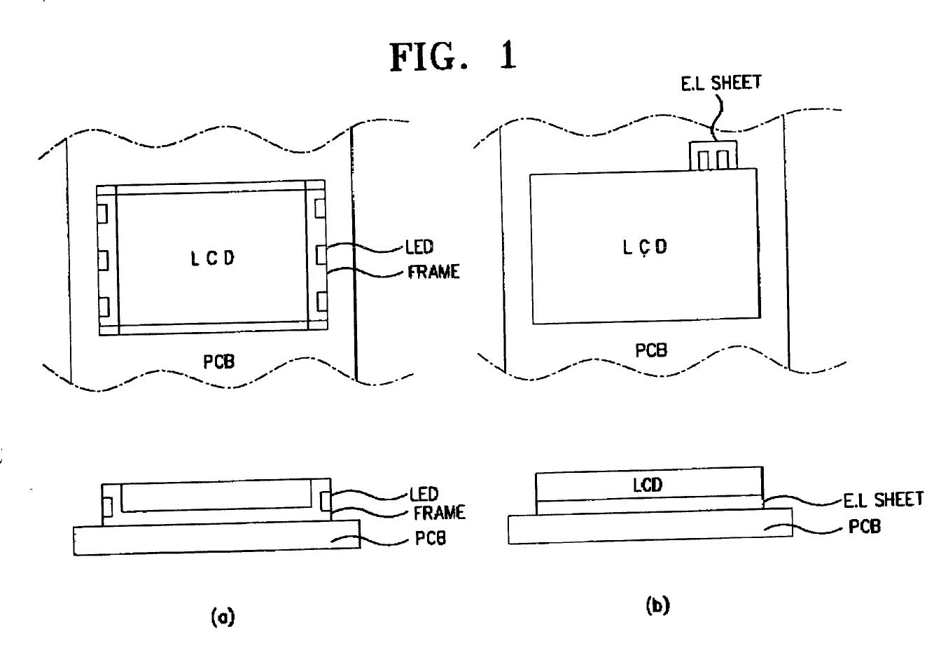

FIG. 2 is a diagram illustrating a back light device in a liquid crystal display module according to a preferred embodiment of the present invention.

### DETAILED DESCRIPTION OF THE PREFERRED EMBODIMENT

A preferred embodiment of the present invention will be described herein below with reference to the accompanying drawings. As for reference numbers, it should be noted that the same reference numbers are attached to the same elements, and further explanation thereof may be omitted. In the following description, well-known functions or constructions are not described in detail since they would obscure the invention in unnecessary detail. A liquid crystal display module illustrated below is a preferred embodiment applied to, for example, a mobile telecommunication set.

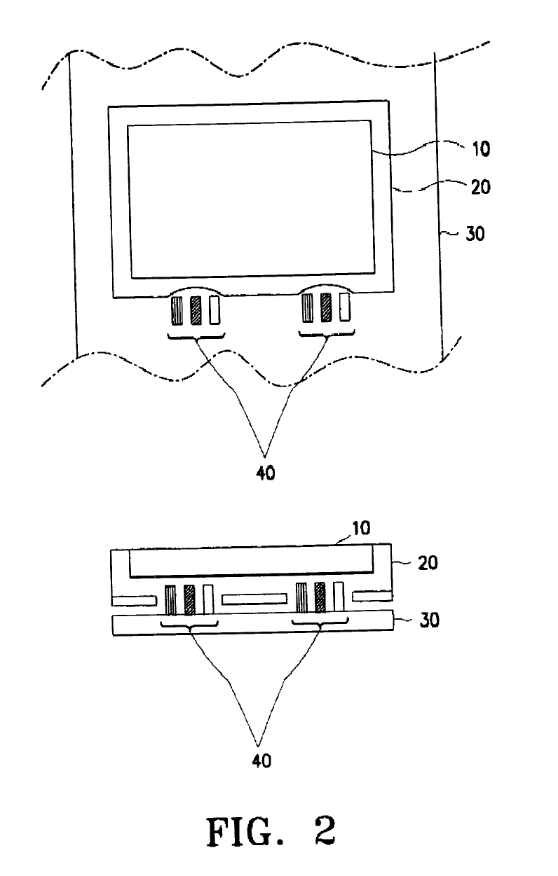

A structure of the liquid crystal display module comprising a back light device will be described herein below with reference to FIG. 2.

FIG. 2 is a diagram illustrating the colored back light device in the liquid crystal display module according to a preferred embodiment of the present invention.

Referring to FIG. 2, reference number 10 represents a liquid crystal display (LCD) where actual information is displayed by an effect of a liquid crystal. To be specific, the information is displayed under control of a controller in the mobile telecommunication set.

Reference number 20 is a back light plate laminated and mounted on a bottom of the liquid crystal display 10. The back light plate is referred to as a reflecting plate. The back light plate allows illuminated light of a lamp discussed below to be diffused, so that the displayed information on the liquid crystal display can be seen in a dark environment. The back light plate has a frame installed on the edge thereof to protect sides of the liquid crystal display, with the inside of the frame mounting the liquid crystal display thereon. The back light plate may be made of diffuse acryl to diffuse the illuminated light.

Reference number 30 represents a printed circuit board (PCB) where the liquid crystal display module is mounted according to the present invention. The printed circuit board supplies a control signal and electric power necessary for driving the liquid crystal display module. Further, the printed circuit board has various elements mounted thereon, which are needed for operation of the mobile telecommunication set. A lamp light emitting diode (LED) in the back light device discussed below is also mounted on the printed circuit board according to the present invention.

Reference number 40 represents the lamp installed on the printed circuit board in both ends of the bottom of the reflecting plate. The lamp comprises LEDs for emitting different colored light, respectively. The lamp according to the present invention comprises LEDs for red, yellow, and blue color so as to display various colors by their combination. Each LED for a different color is selected to emit light of a particular color based on a user's request. The illumination of the LED is conducted according to a control signal applied by a controller in the mobile telecommunication set, and the application of the control signal is performed according to the user's demand.

The operation of the liquid crystal display module having the structure as shown in FIG. 2 will be described herein below.

If a user requests the back light in the liquid crystal display module to be red colored, a control signal for causing only an LED for the color red to emit light is applied to the liquid crystal display module. Thus, only the LED for the color red among the LEDs installed on the both ends of the bottom of the reflecting plate emits light, which is then diffused through the reflecting plate.

If the user requests the color yellow with respect to the back light, an LED for the color yellow only emits light, whereas with a request for the color blue, only an LED for the color blue accordingly emits light. Furthermore, if there is a request of another color than the aforementioned three colors, the operation of the LEDs is properly controlled to emit the requested colored light. For example, if the user wants to have orange colored light, the LED R and LED Y are simultaneously controlled to emit their light. The emitted light by the LED R and LED Y is diffused in the reflecting plate at the same time, rendering the emitted light orange colored as a result. On the same principle, the LED R and B are controlled to simultaneously emit their light when there is a request of a violet colored light. In case of another color than those illustrated, a proper selection of the LEDs and an illumination control accordingly will induce a desired colored back light.

The operation of the liquid crystal display module will be carried out as described in the following.

In a typical mobile telecommunication set, an entry into a menu is accomplished by an input of a menu key. If there is an input of the menu key in the mobile telecommunication set applied in the present invention, the menu for a back light color variation mode is displayed on the LCD. If the menu is selected, the mobile telecommunication set is programmed to enter into the back light color variation mode. If the back light color variation mode selected, the mobile telecommunication set is also programmed so as for a user to select a desired color for the back light by inputting a predetermined orientation key. Thus, the user can select the color of the back light, which is predetermined or combined according to his/her demand, by inputting the orientation key. Hence, the LEDs are controlled to be driven to emit light of the selected color.

The method for controlling the back light color according to the present invention is able to be realized in any other equipment using a liquid crystal display module in conformity with an operational characteristic of the equipment.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A back light device in a liquid crystal display module, the device comprising:
a liquid crystal display;
a laminated reflecting plate positioned on a bottom of the liquid crystal display;
at least two lamps of different color installed on one end of the reflecting plate and positioned a distance from each other; and
a controller for controlling light emission of the lamps, the light emitted by the lamps being diffused through the reflecting plate, wherein the colors emitted by the lamps are combined and diffused light is irradiated according to an illumination control signal applied by the controller, and the illumination control signal causes the irradiated light to match a color according to a user's demand.

2. The device of claim 1, wherein the lamps comprise light emitting diodes (LED) installed on both ends of the bottom of the reflecting plate.

3. The device of claim 2, wherein an LED for emitting light of red, yellow, or blue color is provided.

4. The device of claim 3, wherein the each LED selectively emits the light color in response to the illumination control signal supplied by the controller.

5. A back light device in a liquid crystal display module, the device comprising:
a liquid crystal display;
a reflecting plate, laminated on a bottom of the liquid crystal display, for diffusing light;
at least a pair of sets of illuminating lamps for combining and emitting the light in a requested color through the reflecting plate; and
a controller for controlling the pair of sets of lamps to emit light in a selected color according to a user's request.

6. The device of claim 5, wherein pair of sets of lamps comprise light emitting diodes (LED) installed on both ends of a bottom of the reflecting plate.

7. The device of claim 6, wherein each set of LED's selectively emit light of red, yellow, or blue color under the control of the controller.
